(19) United States
(12) Patent Application Publication
(10) Pub. No.: US 2006/0024446 A1
(43) Pub. Date: Feb. 2, 2006

(54) Substrate processing apparatus and substrate processing method

(75) Inventors: Kenji Sugimoto, Kyoto (JP); Yukihiko Inagaki, Kyoto (JP)

Correspondence Address: OSTROLENK FABER GERB & SOFFEN, 1180 AVENUE OF THE AMERICAS, NEW YORK, NY, 100368403, US

(73) Assignee: DAINIPPON SCREEN MFG. CO., LTD.

(21) Appl. No.: 11/144,530

(22) Filed: Jun. 2, 2005

(30) Foreign Application Priority Data
Jul. 6, 2004 (JP) JP2004-199616

(51) Int. Cl. B05D 3/02

(52) U.S. Cl. 427/377; 118/500

(57) ABSTRACT

A substrate processing apparatus comprises a plurality of second coating processing units responsible for coating, a gas supply mechanism for supplying clean air through a supply path, and a cell controller. Each of the second coating processing units is provided with a control plate and an exhaust fun unit. The opening of the supply path is controlled by adjusting the angle of rotation of the control plate. The cell controller adjusts the angle of rotation of each control plate based on a setting previously determined to independently control the amount of air supply to the second coating processing units. Thus the pressures within the second coating processing units are controlled such that the second coating processing units provide substantially the same processing result. As a result, the difference among the plurality of second coating processing units can be suppressed.

### BACKGROUND OF THE INVENTION

1. Field of the Invention

The present invention relates to atmosphere control in a substrate processing apparatus comprising a plurality of processing units responsible for predetermined processing on a semiconductor substrate, glass substrate for liquid crystal device or the like.

2. Description of the Background Art

In manufacturing process steps of a semiconductor device or liquid crystal device, a substrate processing apparatus is employed which is responsible for various types of processes on a semiconductor substrate or glass substrate. In such a substrate processing apparatus, a plurality of processing units responsible for one process step are provided to improve throughput by means of parallel processing using the plurality of processing units.

If a plurality of units are simply provided, however, these units responsible for the same process step fail to function in exactly the same manner, causing difference in quality among processed substrates. Such difference in quality will be referred to as difference among units.

In order to avoid the difference among units, it has been suggested to provide processing units with the same parameters such as temperature, flow rate of liquid chemical, discharge timing and the like in a process step.

On the other hand, provision of a plurality of units causes increase of a footprint. In response, it has been suggested to arrange an increased number of processing units in stack.

However, even when a plurality of processing units are provided with the same parameters (which more particularly the parameters proposed to exert influence upon processing result), an apparatus of the background art still suffers from the difference among units. This difference among units is noticeable, especially when a plurality of processing units are arranged in stack.

### SUMMARY OF THE INVENTION

The present invention relates to atmosphere control in a substrate processing apparatus comprising a plurality of processing units responsible for predetermined processing on a semiconductor substrate, glass substrate for liquid crystal device or the like.

According to one aspect of the present invention, the substrate processing apparatus comprises: a plurality of processing units responsible for the same processing on a plurality of substrates; and a pressure control element for controlling the pressures within the plurality of processing units such that the plurality of processing units provide substantially the same processing result.

Thus the difference among units can be suppressed.

Preferably, the plurality of processing units include units arranged at different heights.

The plurality of processing units at different heights are subjected to pressure control. Thus the difference among units can be suppressed even in a configuration having seriously suffered from such difference among units.

The present invention is also intended for a substrate processing method. The method comprises the steps of: (a) performing the same processing on a plurality of substrates using a plurality of processing units; and (b) controlling the pressures within the plurality of processing units such that the plurality of processing units provide substantially the same processing result.

It is therefore an object of the present invention to suppress the difference among units while reducing the increase of a footprint caused by the provision of a plurality of units.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a plan view of a substrate processing apparatus according to preferred embodiments of the present invention;

FIG. 2 is a front view of the substrate processing apparatus showing the arrangement of a liquid chemical processor;

FIG. 3 shows the arrangement of a thermal processor;

FIG. 4 shows how clean air is supplied to a second coating processor and a development processor in a first preferred embodiment of the present invention;

FIG. 5 shows how an internal atmosphere is discharged from each of second coating processing units of the second coating processor in the first preferred embodiment;

FIG. 6 is a flow chart showing the operations of the second coating processor according to the first preferred embodiment;

FIG. 7 shows respective processing results an apparatus of the background art and the substrate processing apparatus of the first preferred embodiment produce;

FIG. 8 shows variations of a film thickness taken along the diameter of a thin film of each of three substrates processed in the apparatus of the background art;

FIG. 9 shows variations of a film thickness taken along the diameter of a thin film of each of three substrates processed in the substrate processing apparatus of the first preferred embodiment; and

FIG. 10 shows a second coating processor according to a second preferred embodiment of the present invention.

### DESCRIPTION OF THE PREFERRED EMBODIMENTS

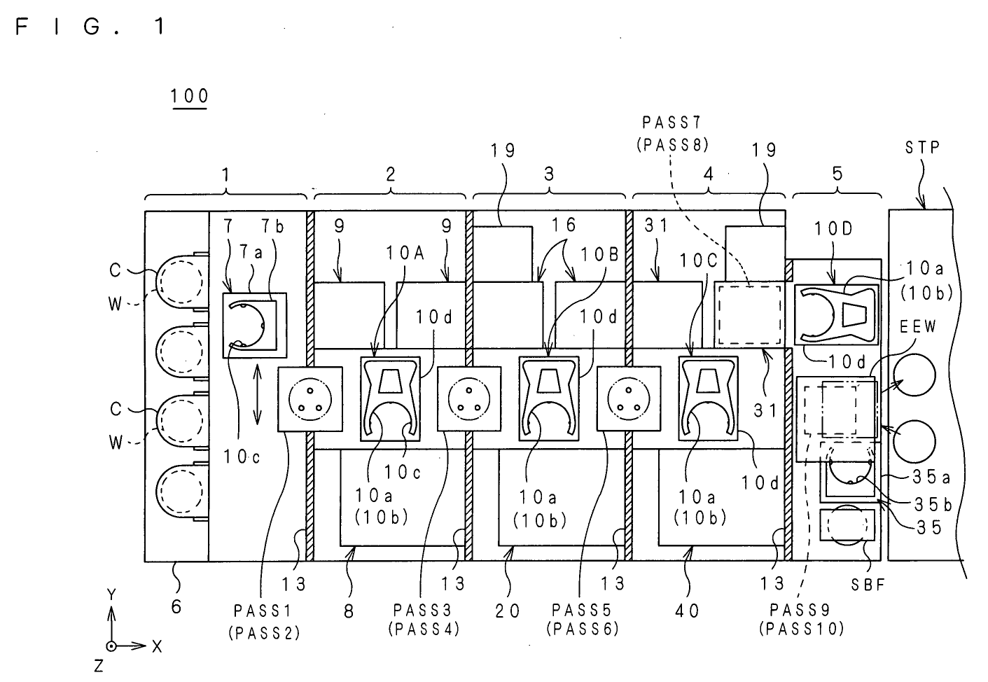

FIG. 1 is a plan view of a substrate processing apparatus 100 according to preferred embodiments of the present invention. The substrate processing apparatus 100 is responsible for example for resist coating, development, and accompanying thermal processing and liquid chemical processing in a photolithography process for forming a certain circuit pattern on a semiconductor substrate (which will be simply referred to as a “substrate”). For the convenience of illustration and description, the vertical direction is defined as a Z-axis direction and the horizontal plane is defined as an XY plane in FIG. 1 and figures following FIG. 1. These definitions are given for the sake of convenience to clarify relative positions. In FIG. 1 and figures following FIG. 1, directions discussed below are not limited by these definitions.

With reference to FIG. 1, the substrate processing apparatus 100 of a first preferred embodiment of the present invention principally comprises a juxtaposition of five blocks including an indexer block (ID block) 1, an anti-reflection film processing block (BARC block) 2, a resist film processing block (SC block) 3, a development block (SD block) 4, and an interface block (IFB block) 5 arranged in this order. An exposure device (stepper) STP is arranged next to the IFB block 5. The exposure device STP serves to form a certain circuit pattern onto a resist film. Each block is individually attached to a frame. The substrate processing apparatus 100 is formed by linking the respective frames of blocks in the foregoing order.

The substrate processing apparatus 100 has a juxtaposition of blocks, whereas its operational control is based on a constituent element as a unit that is a so-called “cell”. Each cell in principle has a target unit of and a cell controller for controlling the target unit. The target unit has at least one processing unit for performing predetermined processing on a substrate W, and a transport mechanism for transferring and receiving a substrate W to and from the processing unit.

The substrate processing apparatus 100 also comprises a main controller Mc responsible for overall control of the cell controllers. The main controller Mc is communicatively connected to a host computer not shown that is responsible for management throughout the semiconductor manufacturing steps for which the substrate processing apparatus 100 of the first preferred embodiment is installed.

The main controller Mc and each cell controller control each part according to recipe data previously prepared, whereby the substrate processing apparatus 100 becomes operative. The recipe data is created for each cell, and the description thereof includes identification of a substrate holding part PASS as access for a substrate to each cell, settings related to transport such as transport order or timing, settings defining processing conditions in each processing unit. The recipe data is also created for a batch of substrates to be processed that may be a single substrate or an assembly of several substrates (a group of substrates stored in the same cassette or a group of a predetermined number of substrates). Thus the substrate processing apparatus 100 may be interpreted as an apparatus in which a processing flow is defined for each batch and each one of substrates included in this batch is subjected to predetermined processing based on this processing flow.

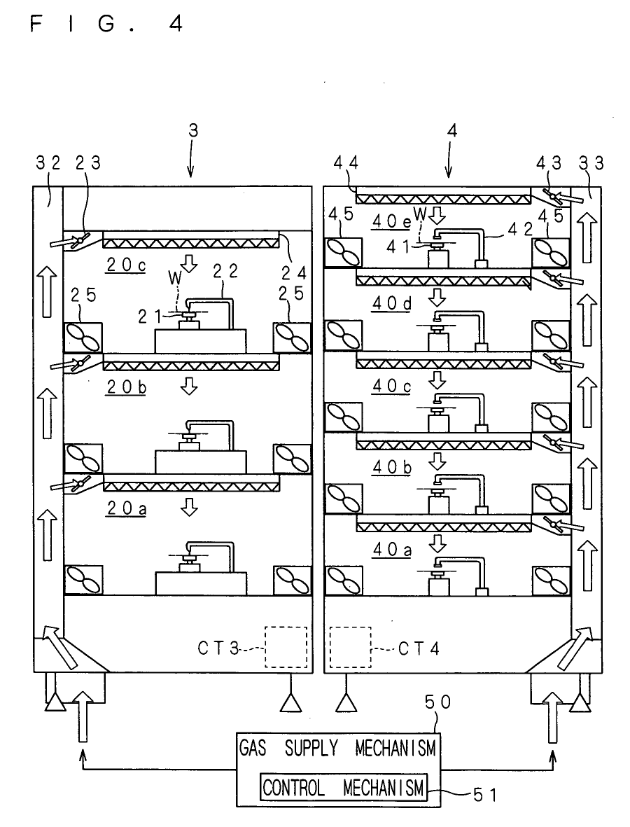

In the substrate processing apparatus 100, a gas supply mechanism 50 (FIG. 4) supplies a downflow of clean air into each block to prevent adverse effects caused by raised particles and gas flows upon the processes in each block. Each block is held at a slightly positive pressure inside relative to the outside to prevent entry of particles and contaminants. In particular, the pressure within the BARC block 2 is set to be higher than that within the ID block 1. The atmosphere within the ID block 1 is thus prevented from flowing into the BARC block 2, whereby each processing block is allowed to perform its process without being influenced by the atmosphere outside the apparatus 100. It will be discussed later how the pressure within each cell is controlled by the main controller Mc (cell controller) and the gas supply mechanism 50.

The ID block 1 serves to receive unprocessed substrates W from the outside of the substrate processing apparatus 100 and to transfer processed substrates W to the outside. The ID block 1 comprises a cassette table 6 and an indexer-specific transport mechanism 7.

The cassette table 6 is capable of placing thereon a plurality of (in FIG. 1, four) cassettes C in a row each capable of storing a predetermined number of substrates W in tiers.

The indexer-specific transport mechanism 7 includes a movable table 7a horizontally movable in the Y-axis direction along the cassette table 6, a holding arm 7b provided over the movable table 7a for holding a substrate W in a horizontal position, and a plurality of (in FIG. 1, three) pins 10c projecting inwardly from a distal end portion of the holding arm 7b (see FIG. 1). The holding arm 7b is capable of moving vertically in the Z-axis direction, pivoting within the horizontal plane, and moving back and forth in the direction of the pivot radius. A substrate W is held in the horizontal position by the pins 10c. With this configuration, the indexer-specific transport mechanism 7 takes out unprocessed substrates W in order from the cassettes C for post-stage processing, and receives processed substrates W to return the same to the cassettes C in order.

It will be briefly discussed how a substrate W is transferred in the ID block 1. First, the indexer-specific transport mechanism 7 moves horizontally to a position opposed to a predetermined one of the cassettes C. Next, the holding arm 7b moves up and down, further moving back and forth to take out an unprocessed substrate W from this cassette C. With the substrate W held by the holding arm 7b, the indexer-specific transport mechanism 7 moves horizontally to a position opposed to substrate holding parts PASS1 and PASS2 discussed below. The indexer-specific transport mechanism 7 transfers the substrate W held on the holding arm 7b onto the upper substrate holding part PASS1 for outward transfer of substrates. If a processed substrate W is placed on the lower substrate holding part PASS2 for return of substrates, the indexer-specific transport mechanism 7 receives this processed substrate W on the holding arm 7b to store the same into a predetermined one of the cassettes C. The indexer-specific transport mechanism 7 repeats the process including taking of an unprocessed substrate W out of the cassette C to transport the same to the substrate holding part PASS1, and receipt of a processed substrate W from the substrate holding part PASS2 to store the same into the cassette C.

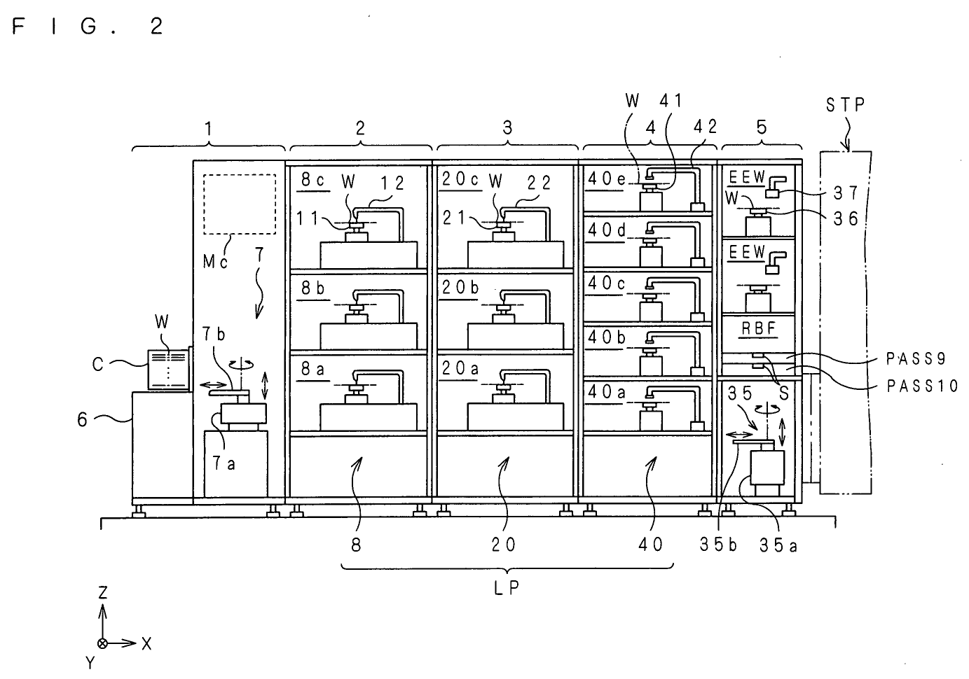

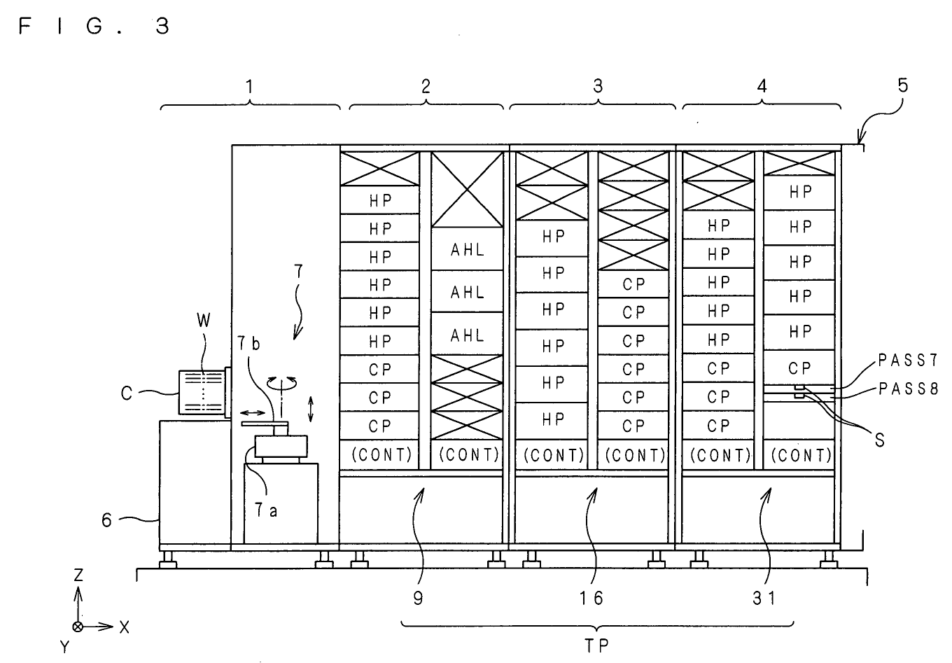

FIG. 2 is a front view of the substrate processing apparatus 100 showing the arrangement of a liquid chemical processor LP. FIG. 3 shows the arrangement of a thermal processor TP as seen in the same direction as in FIG. 2 (in the −Y direction). Next, the BARC block 2, SC block 3 and SD block 4 will be described with reference to FIGS. 1, 2 and 3.

The BARC block 2 is responsible for formation of an anti-reflection film under a photoresist film for reducing standing waves or halation occurring during exposure in the exposure device STP. The BARC block 2 comprises a first coating processor 8 for coating the surface of a substrate W with an anti-reflection film, a first thermal processor 9 responsible for thermal process required for the coating, and a first main transport mechanism 10A for transferring and receiving a substrate W to and from the first coating processor 8 and the first thermal processor 9.

The SC block 3 is responsible for formation of a photoresist film on a substrate W provided with an anti-reflection film. The first preferred embodiment uses a chemically amplified resist as a photoresist. The SC block 3 comprises a second coating processor 20 for coating with a photoresist film, a second thermal processor 16 responsible for thermal process required for the coating, and a second main transport mechanism 10B for transferring and receiving a substrate W to and from the second coating processor 20 and the second thermal processor 16.

The SD block 4 is responsible for development upon a substrate W provided with a predetermined circuit pattern by exposure at the exposure device STP. The SD block 4 comprises a development processor 40 for development using a developing solution, a third thermal processor 31 for thermal process required for the development, and a third main transport mechanism 10C for transferring and receiving a substrate W to and from the development processor 40 and the third thermal processor 31.

The first, second and third main transport mechanisms 10A, 10B and 10C in the BARC block 2, SC block 3 and SD block 4 will be collectively referred to as a “main transport mechanism 10”. The first coating processor 8, second coating processor 20 and development processor 40 will be collectively referred to as the “liquid chemical processor LP”. The first, second and third thermal processors 9, 16 and 31 will be collectively referred to as the “thermal processor TP”.

With reference to FIG. 1, in each of the BARC block 2, SC block 3 and SD block 4, the liquid chemical processor LP and the thermal processor TP are respectively positioned on the front side and the rear side of the substrate processing apparatus 100, with the main transport mechanism 10 held therebetween. That is, in each of the BARC block 2, SC block 3 and SD block 4, the liquid chemical processor LP responsible for processing using a certain liquid chemical and the thermal processor TP responsible for thermal processing are spaced apart from each other with the main transport mechanism 10 held therebetween. Such an arrangement suppresses thermal effect upon the liquid chemical processor LP caused by the thermal processor TP. Further, in the substrate processing apparatus 100 of the first preferred embodiment, the front side of the thermal processor TP (on the side of the main transport mechanism 10) is provided with a thermal barrier not shown which also avoids thermal effect upon the liquid chemical processor LP.

With reference to FIG. 2, the first and second coating processors 8 and 20, and the development processor 40 constituting the liquid chemical processor LP each have a plurality of processing units arranged in vertically stacked relation.

The first coating processor 8 includes first coating processing units 8a, 8b and 8c (three in total) arranged in vertically stacked relation. The first coating processing units 8a, 8b and 8c each have a spin chuck 11 for rotating a substrate W while holding the same under suction in a horizontal position, a nozzle 12 for supplying a coating of a solution for forming an anti-reflection film onto the substrate W held on the spin chuck 11 and the like.

Likewise, the second coating processor 20 includes second coating processing units 20a, 20b and 20c (three in total) arranged in vertically stacked relation. The second coating processing units 20a, 20b and 20c each have a spin chuck 21 for rotating a substrate W while holding the same under suction in a horizontal position, a nozzle 22 for supplying a coating of a solution for forming a resist film onto the substrate W held on the spin chuck 21, and the like.

The development processor 40 includes development units 40a through 40e (five in total) arranged in vertically stacked relation. The development units 40a through 40e each have a spin chuck 41 for rotating a substrate W while holding the same under suction in a horizontal position, a nozzle 42 for supplying a developing solution onto the substrate W held on the spin chuck 41, and the like.

With reference to FIG. 3, the first, second and third thermal processors 9, 16 and 31 constituting the thermal processor TP each have two stacks of a plurality of processing units arranged in vertically stacked relation.

The first thermal processor 9 has a plurality of heating plates HP capable of heating a substrate W to a predetermined temperature and maintaining the heated substrate W at this temperature, a plurality of cooling plates CP capable of cooling a heated substrate W to a predetermined temperature and maintaining the cooled substrate at this temperature, and a plurality of adhesion processing units AHL responsible for thermal processing on a substrate W in vapor atmosphere containing HMDS (Hexamethyldisilazane) to enhance adhesion of a resist film to a substrate W. The lower part of each thermal processor is provided with heater controllers CONT responsible for control of each part of the thermal processor TP. The locations indicated by cross marks (X) in FIG. 3 are occupied by piping and wiring, or are reserved as empty space for future provision of other processing units.

Likewise, the second and third thermal processors 16 and 31 each have processing units including a plurality of heating plates HP, a plurality of cooling plates CP and the like. Like the first thermal processor 9, processing units are also arranged in two vertical stacks. The third thermal processor 31 also includes substrate holding parts PASS7 and PASS8 discussed later.

Some of the heating plates HP may be equipped with temporary holding parts (not shown) for temporarily placing thereon a heated substrate W. In this case, the heated substrate W is transferred once from a local transport robot (not shown) onto the temporary holding part. Then the main transport mechanism 10B or 10C is allowed to access the temporary holding part to receive the substrate W. That is, the main transport mechanism 10B and 10C do not directly contact the heating plate HP (more specifically, a heated part of the heating plate HP) for transfer of a substrate W, thereby minimizing thermal effect upon the main transport mechanisms 10B and 10C. In FIG. 1, temporary substrate holding parts 19 are shown by way of example to be provided to the second and third thermal processors 16 and 31.

Next, the main transport mechanism 10 (10A, 10B and 10C) will be discussed. A fourth main transport mechanism 10D provided in the IFB block 5 and discussed below has the same configuration.

The main transport mechanism 10 has a base 10d, and two (upper and lower) holding arms 10a and 10b (only one of which is shown in FIG. 1) that are provided on the base 10d. The holding arms 10a and 10b each have a substantially C-shaped distal end portion provided with a plurality of (in FIG. 1, three) pins 10c projecting inwardly therefrom. The pins 10c serve to hold a substrate W in a horizontal position. The holding arms 10a and 10b are driven by a driving mechanism not shown to be capable of pivoting within the horizontal plane, moving vertically in the Z-axis direction, and moving back and forth in the direction of the pivot radius.

The IFB block 5 is responsible for transfer of substrates W between the substrate processing apparatus 100 and the exposure device STP adjacent to the substrate processing apparatus 100. The IFB block 5 mainly comprises: an interface-specific transport mechanism 35 for transferring and receiving a substrate W to and from the exposure device STP; two edge exposure units EEW for exposing in advance the periphery of a substrate W coated with a photoresist; a feed buffer SBF for temporarily storing a substrate W when the exposure device STP fails to accept the substrate W; a return buffer RBF for storing a substrate W when the processing part responsible for post-stage processing fails to process the substrate W after being subjected to exposure; substrate holding parts PASS9 and PASS10 discussed below for transferring and receiving a substrate W to and from the fourth main transport mechanism 10D and the interface-specific transport mechanism 35; and the fourth main transport mechanism 10D adjacent to the edge exposure units EEW and the heating plates HP in the SD block 4 and responsible for transfer and receipt of a substrate W to and from the edge exposure units EEW and these heating plates HP. The two edge exposure units EEW, return buffer RBF and substrate holding parts PASS9 and PASS10 are vertically stacked in this order from top to bottom. The feed buffer SBF and the return buffer RBF each have a cabinet capable of storing more than two substrates in tiers.

With reference to FIG. 2, the edge exposure units EEW each have a spin chuck 36 for rotating a substrate W while holding the same under suction in a horizontal position, a light irradiator 37 for exposing the periphery of the substrate W held on the spin chuck 36 to light, and the like. The two edge exposure units EEW are arranged in vertically stacked relation in the center of the IFB block 5.

With reference to FIG. 2, the interface-specific transport mechanism 35 includes a movable table 35a capable of making movement in a horizontal direction (the Y-axis direction), and a holding arm 35b provided over the movable table 35a for holding a substrate W. The holding arm 35b is capable of moving up and down, pivoting, and moving back and forth in the direction of the pivot radius by driving means not shown. The range of horizontal movement of the interface-specific transport mechanism 35 extends to a position under the stack of the substrate holding parts PASS9 and PASS10, at which a substrate W is transferred and received to and from the exposure device STP. At an opposite position of the range of movement of the interface-specific transport mechanism 35, a substrate W is transferred and received to and from the substrate holding parts PASS9 and PASS10, and is also stored into and taken out from the feed buffer SBF.

Next, transfer of a substrate W in the substrate processing apparatus 100 will be discussed placing emphasis on the transfer between adjacent blocks. In the substrate processing apparatus 100, each boundary between adjacent blocks is provided with a partition 13 which serves to provide atmospheric isolation between the blocks. The upper and lower substrate holding parts PASS1 and PASS2, upper and lower substrate holding parts PASS3 and PASS4, and upper and lower substrate holding parts PASS5 and PASS6 are provided as pairs to the respective partitions 13 while partially penetrating the partitions 13. Cooling plates for cooling a substrate W are provided under the substrate holding parts PASS4 and PASS6.

The substrate holding parts PASS1 and PASS2 are arranged in this order from top to bottom between the ID block 1 and the BARC block 2. The substrate holding parts PASS3 and PASS4 are arranged in a similar manner between the BARC block 2 and the SC block 3. The substrate holding parts PASS5 and PASS6 are arranged in a similar manner between the SC block 3 and the SD block 4.

The substrate holding parts PASS7 and PASS8 for transferring and receiving a substrate W to and from the SD block 4 and the IFB block 5 are arranged in the third thermal processor 31 of the SD block 4. As discussed above, the substrate holding parts PASS9 and PASS10 are arranged in the IFB block 5. The substrate holding parts PASS1 through PASS10 will be collectively referred to as a substrate holding part PASS.

The substrate holding parts PASS1 through PASS10 each have a plurality of support pins not shown capable of supporting a substrate W, and an optical sensor S. The optical sensor S serves to detect the presence of a substrate W on the support pins.

The ten substrate holding parts PASS1 through PASS10 are arranged on the upper and lower sides at five positions. The upper substrate holding parts PASS are intended for transfer in principle in a direction in which a substrate W is transported from the ID block 1 toward the exposure device STP (which will be referred to as a “feed direction”). The lower substrate holding parts PASS are intended for transfer in principle in a direction in which a substrate is transported from the exposure device STP toward the ID block 1 (which will be referred to as a “return direction”).

As discussed, the substrate processing apparatus 100 is controlled on a cell basis. Thus it is considered that the substrate processing apparatus 100 comprises a juxtaposition of six cells independently operable, and that the substrate holding parts PASS1 through PASS10 are responsible for transfer of substrates between cells.

It will be discussed how a substrate is transferred between adjacent cells and how a substrate is transferred within one cell, taking an SC cell C3 as an example.

The substrate holding part PASS3 is an entrance to the SC cell C3 in the feed direction for receiving a substrate W from an adjacent BARC cell C2. The substrate holding part PASS serving to function as an entrance for a substrate W to each cell in the feed direction will be referred to as a “feed-specific entrance pass” SI. Likewise, an exist in the feed direction, an entrance in the return direction and an exit in the return direction will be respectively referred to as a “feed-specific exit pass” SO, as a “return-specific entrance pass” RI and as a “return-specific exit pass” RO. Regarding the SC cell C3, the substrate holding parts PASS5, PASS6 and PASS4 are respectively operative to function as the pass SO, pass RI and pass RO.

When an unprocessed substrate W is transferred from the first main transport mechanism 10A in the BARC cell C2 onto the substrate holding part PASS3 as the feed-specific entrance pass SI to the SC cell C3, the optical sensor S of the substrate holding part PASS3 detects the presence of this substrate W. Responsive to a signal generated at this time indicating the presence or absence of the substrate W, a cell controller CT3 responsible for control of the SC cell C3 controls the second main transport mechanism 10B in the SC cell C3 to receive the substrate W held on the substrate holding part PASS3 at a certain time. When the second main transport mechanism 10B holds a substrate W to be returned to the BARC cell C2 through the substrate holding part PASS4 as the return-specific exit pass RO, the cell controller CT3 also controls the second main transport mechanism 10B to return this substrate W.

For transfer of substrates W, the second main transport mechanism 10B causes the holding arms 10a and 10b to together move up and down and pivot to respective positions opposed to the substrate holding parts PASS3 and PASS4. Then a processed substrate held on the holding arm 10b is transferred onto the substrate holding part PASS4 as the return-specific exit pass RO. Thereafter the empty holding arm 10b is driven again to receive a substrate W held on the substrate holding part PASS3 as the feed-specific entrance pass SI. That is, only the holding arm 10b is responsible for transfer of substrates W.

Thus the substrate holding part PASS3 is emptied whereas a substrate is held on the substrate holding part PASS4. The respective optical sensors S of the substrate holding parts PASS3 and PASS4 detect the presence or absence of a substrate, and a signal indicating the respective states of the substrate holding parts PASS3 and PASS4 is sent to a cell controller CT2 of the BARC cell C2. In response to this signal, transfer of subsequent substrates W to the BARC cell C2 is allowed.

After transfer and receipt of substrates W to and from the substrate holding parts PASS3 and PASS4, the second main transport mechanism 10B transports a received substrate W in principle to a predetermined processing unit under control of the cell controller CT3 based on the settings of recipe data RD. In the case of the SC cell C3, the substrate W is transported to any one of the cooling plates CP, heating plates HP and second coating processing units 20a, 20b and 20c. The second main transport mechanism 10B causes the empty holding arm 10a with no substrate W and the holding arm 10b holding the substrate W to together move up and down and pivot to a position opposed to a certain processing unit to which the substrate W is to be transported. The processing unit to receive the substrate W generally contains a substrate W previously processed. First, the empty arm 10a is moved forward to receive the substrate W previously processed in the certain processing unit. Next, the holding arm 10b holding the unprocessed substrate W is moved forward to transfer this substrate W to a prescribed position in the certain processing unit.

The second main transport mechanism 10B continues to transfer and receive substrates to and from the certain processing unit by means of the holding arms 10a and 10b under control of the cell controller CT3 based on the settings of the recipe data RD. That is, one holding arm holding no substrate W receives a substrate W processed in the certain processing unit whereas a substrate W held on another holding arm is transferred to a prescribed position in the certain processing unit. However, when the second main transport mechanism 10B receives a substrate W processed in the heating plate HP, only one of the holding arm 10a or 10b is controlled to be operable. This suppresses thermal effect upon a substrate W from the holding arms 10a and 10b and minimize “fluctuations” of such thermal effect.

A substrate W after having been sequentially transferred between some processing units and having been subjected to certain processes thereat is transferred onto the substrate holding part PASS5 as the feed-specific exit pass SO to be sent from the SC cell C3 to an SD cell C4. The transfer from the SC cell C3 to the SD cell C4 follows the similar process to that in the transfer from the BARC cell C2 to the SC cell C3. Depending on the settings of the recipe data RD, a substrate W after being subjected to certain processing in the SC cell C3 may be returned from the substrate holding part PASS4 as the return-specific exit pass RO to the BARC cell C2 without being subjected to processing in a post-stage cell. Alternatively, a substrate W received in the SC cell C3 may be immediately transferred to the SD cell C4 without being subjected to processing at processing units in the SC cell C3. In these cases, the basic operations for transfer of a substrate W between cells are based on the same principle. When a substrate W after being subjected to exposure and the like is to be returned in the return direction to an ID cell C1, the substrate W is received from the substrate holding part PASS6 as the return-specific entrance pass RI and directly transferred onto the substrate holding part PASS4 as the return-specific exit pass RO at a certain time. This transfer and receipt follow the same process as discussed.

As discussed, in the SC cell C3, the cell controller CT3 is responsible for control of the operations of the second main transport mechanism 10B and each processing unit based on the settings of the recipe data RD. Except that the operations of the SC cell C3 are responsive to a signal indicating the presence of a substrate W on the feed-specific entrance pass SI or on the return-specific entrance pass RI, the processing in the SC cell C3 proceeds independently of adjacent cells.

This also applies to the other cells, though the details of processing vary among cells. That is, the cell controllers CT1 through CT6 are independently responsible for a series of control operations starting from receipt of a substrate W held on the corresponding feed-specific entrance pass SI or on the corresponding return-specific entrance pass RI, followed by sequential transfer of the substrate W between predetermined processing units, and transfer of the substrate W after being subjected to certain processing onto the corresponding feed-specific exit pass SO or onto the corresponding return-specific exit pass RO. The cell controllers CT1 through CT6 are independently responsible for a series of control including these process steps by the recipe data RD prepared for each cell. More specifically, it is defined on a cell basis to which a substrate W received from a processing unit or from the substrate holding part PASS is transported by a transport mechanism, how this transport is timed to occur and how substrates are assigned priorities, and how a substrate is processed under certain processing conditions in each processing unit.

This means, in the substrate processing apparatus 100, transport and processing are realized in each cell based on the recipe data RD independently of those in other cells, and the processing of the apparatus as a whole proceeds with the independent processing in each cell. Except that the presence or absence of a substrate W on the four substrate holding parts PASS at most as access for a substrate W is referred to, transfer itself of a substrate W between adjacent cells is not directly controlled. Thus the operation in one cell has reduced effect upon another cell. This provides simplified control of the apparatus as a whole as well as easy and flexible operation setting of the recipe data RD.

Thus each of the cell controllers CT1 through CT6 is responsible for the control only of transfer of a substrate W by a transport mechanism and operation of a processing unit in a corresponding cell, without considering the operation in an adjacent cell. As a result, a burden of control placed on each of the cell controllers CT1 through CT6 is relatively light, and the control of the apparatus as a whole is facilitated as compared to a background-art control method that controls overall transport operations of the apparatus together.

When a new processing unit and the like are introduced to the apparatus, the background-art control method requires considerable changes in a control program. In contrast, the present invention only requires recipe data RD corresponding to a newly introduced cell, without exerting effect upon the control of an existing cell adjacent to the new cell. Thus a new cell can be introduced in an easy and flexible manner. By way of example, a cell including an inspection unit for inspecting the thickness or linewidth of a resist film and a transport mechanism responsible for transport within the cell may be interposed between the SC cell C3 and SD cell C4.

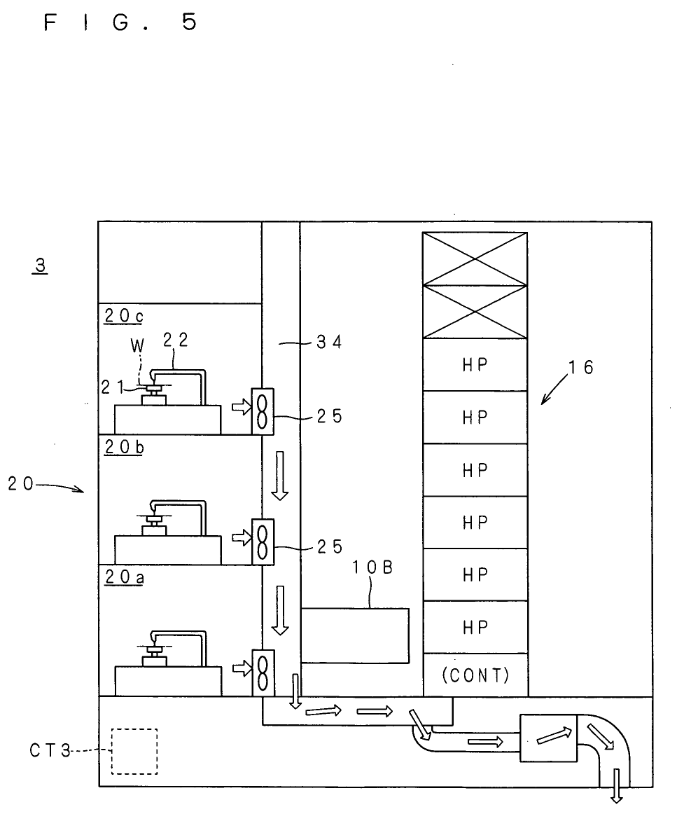

In the substrate processing apparatus 100 with the foregoing configuration, each processing unit in each cell is subjected to independent pressure control. Such control will be discussed making reference to the second coating processor 20 and the development processor 40 as examples. FIG. 4 shows how clean air is supplied to the second coating processor 20 and the development processor 40. FIG. 5 shows how the internal atmosphere is discharged from each of the second coating processing units 20a, 20b and 20c of the second coating processor 20.

The gas supply mechanism 50 has a control mechanism 51 for controlling air temperature and humidity. The gas supply mechanism 50 supplies clean air controlled by the control mechanism 51 to each cell, whereby the atmosphere in the substrate processing apparatus 100 can be controlled suitably for the processing performed in each cell (processing unit). The gas supplied from the gas supply mechanism 50 is not limited to air, although it is preferably air or inert gas such as nitrogen gas.

The second coating processor 20 has a supply path 32 for distributing air supplied from the gas supply mechanism 50 among the second coating processing units 20a, 20b and 20c. The development processor 40 has a supply path 33 for distributing air supplied from the gas supply mechanism 50 among the development units 40a through 40e.

In addition to the spin chuck 21 and the nozzle 22 discussed above, each of the second coating processing units 20a, 20b and 20c of the second coating processor 20 has a control plate 23, an intake filter unit 24 and a pair of exhaust fan units 25.

The control plate 23 controls the opening of a pipe for introducing air from the supply path 32 into each of the second coating processing units 20a, 20b and 20c. The amount of air supply to the inside increases by the greater degree of opening of the pipe. The amount of air supply degreases by the lower degree of opening of the pipe. That is, in the substrate processing apparatus 100, the angle of rotation of each control plate 23 is adjusted by the cell controller CT3 such that the amount of air supply to each of the second coating processing units 20a, 20b and 20c is controlled.

The pressure within each of the second coating processing units 20a, 20b and 20c increases as the amount of air supply increases. Thus, in the substrate processing apparatus 100, the pressure within each of the second coating processing units 20a, 20b and 20c can be controlled by adjusting the angle of rotation of each control plate 23 and controlling the amount of air supply.

The intake filter unit 24 allows air taken from the supply path 32 to pass through the filter and then supplies the filtered air into each of the second coating processing units 20a, 20b and 20c, whereby particles are eliminated from the air. Each part of the substrate processing apparatus 100 is supplied with clean air from the gas supply mechanism 50. However, before reaching each of the second coating processing units 20a, 20b and 20c, air supplied from the gas supply mechanism 50 may receive dust particles therein existing in the piping system such as the supply path 32. In response, clean air can be supplied to each of the coating processing units 20a, 20b and 20c by the action of the intake filter units 24. Thus splash of dust particles and the like can be prevented.

The pair of exhaust fan units 25 are arranged at the lower part of each of the second coating processing units 20a, 20b and 20c. The exhaust fan units 25 each have a rotating motor whose speed and direction of rotation are controlled in response to a control signal sent from the cell controller CT3, and a fan caused to rotate by the rotating motor. The exhaust fan units 25 cause the internal atmosphere to be discharged through an exhaust path 34 by the rotation of the fans in a prescribed direction. Further, the amount of discharge of the internal atmosphere is increased or decreased by controlling the number of revolutions of the fans.

The pressure within each of the second coating processing units 20a, 20b and 20c drops as the amount of discharge of the internal atmosphere increases. Thus, in the substrate processing apparatus 100, the pressure within each of the second coating processing units 20a, 20b and 20c can also be controlled by controlling the number of revolutions of the fans and controlling the amount of discharge of the internal atmosphere.

The intake filter units 24 are arranged at the upper part of each of the second coating processing units 20a, 20b and 20c as shown in FIG. 4, thereby supplying air from the upper part into each of the second coating processing units 20a, 20b and 20c. The exhaust fan units 25 are arranged at the lower part of each of the second coating processing units 20a, 20b and 20c, thereby discharging the internal atmosphere from the lower part of each of the second coating processing units 20a, 20b and 20c through the exhaust path 34. Accordingly, in the substrate processing apparatus 100, a downflow can be efficiently provided inside the second coating processing units 20a, 20b and 20c.

Like the second coating processor 20, the development units 40a through 40e of the development processor 40 each have a control plate 43, an intake filter unit 44 and a pair of exhaust fan units 45. Except that the development units 40a through 40e are stacked in five tiers, the development processor 40 has substantially the same structure as those of the second coating processor 20.

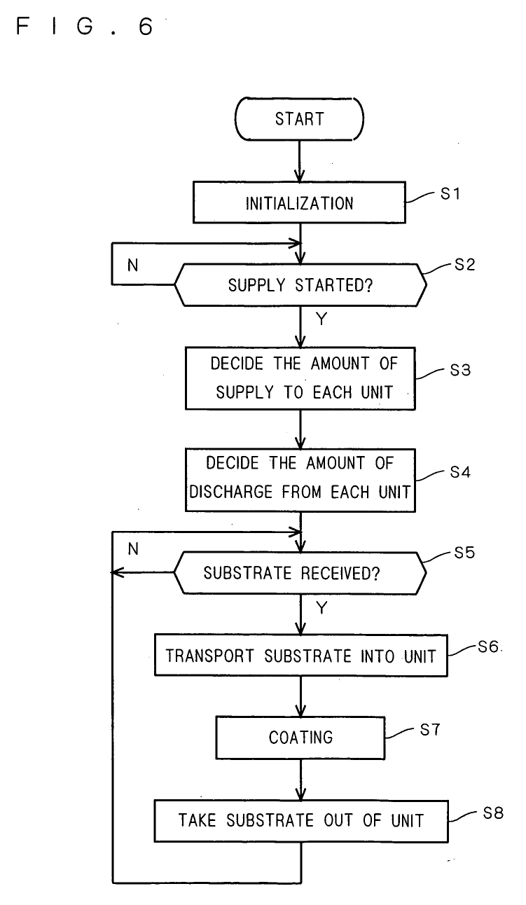

FIG. 6 is a flow chart showing the operations of the second coating processor 20 according to the first preferred embodiment. First, in an initialization step (step S1), the cell controller CT3 of the second coating processor 20 obtains settings stored in advance as a recipe including the angle of rotation of each control plate 23, the speed of rotation of the fan of each exhaust fan unit 25 and the like.

These settings are previously obtained for example by experiment and then stored such that the second coating processing units 20a, 20b and 20c provide substantially the same processing result. In the substrate processing apparatus 100 of the first preferred embodiment, the respective fans of the exhaust fan units 25 are rotated at the same revolutions (fixed value), and the amount of air supply (amount of air blow) from the gas supply mechanism 50 is set to a predetermined value (fixed value). The angle of rotation of each control plate is changed in various ways and experimental coating is performed in each of the second coating processing units 20a, 20b and 20c. Then processed substrates W are evaluated. A combination of the angles of rotation of the control plates 23 allowing the second coating processing units 20a, 20b and 20c to provide substantially the same processing result is decided. Then these values are defined as the respective settings of the control plates 23.

Even when the fans of all the exhaust fan units 25 are rotated at the same revolutions, the amount of discharge may vary as a result of individual differences of fans or difference in pressure, for example. Even when the air blow from the gas supply mechanism 50 is kept at a constant level, the amount of air supply from the gas supply mechanism 50 to the second coating processing units 20a, 20b and 20c slightly varies depending on the difference of distance in the supply path 32 to the units 20a, 20b and 20c, difference of height among the units 20a, 20b and 20c or the like.

In response, in the substrate processing apparatus 100 of the first preferred embodiment, the angle of rotation of each control plate 23 is independently controlled based on the setting previously obtained to control the amount of air supply to each of the second coating processing units 20a, 20b and 20c. As a result, the difference among units caused by these various factors can be overcome.

In order to overcome the difference among units, the configuration of the substrate processing apparatus 100 also allows control of the amount of discharge of the internal atmosphere as discussed. Like the control of the amount of air supply, the amount of discharge of the internal atmosphere may also be controlled in a similar manner. Alternatively, only the amount of discharge of the internal atmosphere may be controlled while the amount of air supply (the angle of rotation of each control plate 23) is kept at a constant level.

After initialization step, the second coating processor 20 is placed in standby until the gas supply mechanism 50 starts air supply (step S2). When air supply is started, the angle of rotation of the control plate 23 in each of the second coating processing units 20a, 20b and 20c is set to the value obtained in step S1.

The cell controller CT3 thereby decides the amount of air supply to each of the second coating processing units 20a, 20b and 20c (step S3). That is, in step S3, the amount of air supply to the second coating processing units 20a, 20b and 20c is controlled based on the settings such that air is supplied by a certain amount (flow rate) through the intake filter unit 24 into the upper part of each of the second coating processing units 20a, 20b and 20c. By the time air supply is started, the control mechanism 51 of the gas supply mechanism 50 executes a control step (not shown) in which the temperature and humidity of air to be supplied are controlled in advance.

In parallel with step S3, the fans constituting the exhaust fan units 25 in each of the second coating processing units 20a, 20b and 20c are rotated based on the settings (fixed values) obtained in step S1. Then the cell controller CT3 decides the amount of discharge of the internal atmosphere from each of the second coating processing units 20a, 20b and 20c (step S4). That is, steps S3 and S4 mainly correspond to the start of pressure control.

When the pressure control in each of the second coating processing units 20a, 20b and 20c is completed, the second coating processor 20 is placed in standby until a substrate W to be processed is transported from the BARC block 2 to the substrate holding part PASS3 (step S5).

When the optical sensor S of the substrate holding part PASS3 detects the presence of a substrate W, the cell controller CT3 controls the second main transport mechanism 10B in response to a signal indicating the presence of a substrate W. The substrate W is then transferred onto the second main transport mechanism 10B. The cell controller CT3 also controls the second main transport mechanism 10B to transport the received substrate W into any one of the second coating processing units 20a, 20b and 20c (step S6).

After receipt of the substrate W, the second coating processing unit 20a, 20b or 20c performs coating by rotating the substrate W while holding the same on the spin chuck 21 and supplying a solution onto the substrate W from the nozzle 22 (step S7). The substrate W after being subjected to coating is taken out and transported again by the second main transport mechanism 10B for post-stage processing (step S8). In the substrate processing apparatus 100, the control plates 23 and the exhaust fan units 25 continue pressure control, whereby the repeatability of processing conditions for coating is maintained.

A substrate W transferred from the BARC block 2 onto the substrate holding part PASS3 may be required to be subjected to cooling, heating or the like before coating at the second coating processor 20. In this case, the cell controller CT3 once transports this substrate W to the cooling plate CP or heating plate HP, and thereafter transports the substrate W to one of the coating processing units 20a, 20b and 20c. In further detail, the cell controller CT3 continues to execute step S5 while steps S6 through S8 are executed to monitor the presence of a substrate W newly transported to the second coating processor 20.

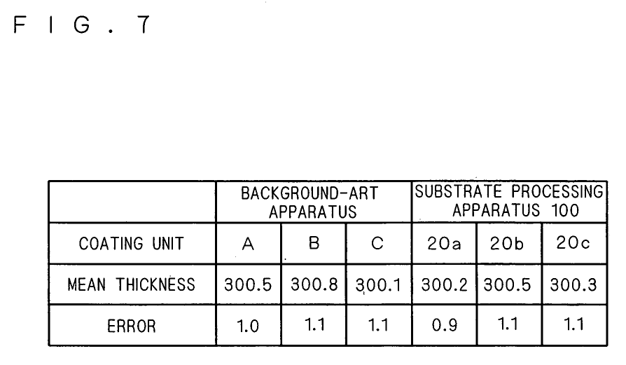

FIG. 7 shows respective processing results an apparatus of the background art and the substrate processing apparatus 100 produce. Coating units A, B and C are vertically stacked in three tiers, with the coating unit A at the bottom and the coating unit C at the top. “Mean thicknesses” shown in FIG. 7 are average values of the thicknesses of thin films (in units of nanometers) measured along diameters of the thin films that are formed on substrates W after being subjected to processing at each coating unit. The processing results shown in FIG. 7 are obtained in the case in which the coating units have been subjected to uniformity control except pressure control

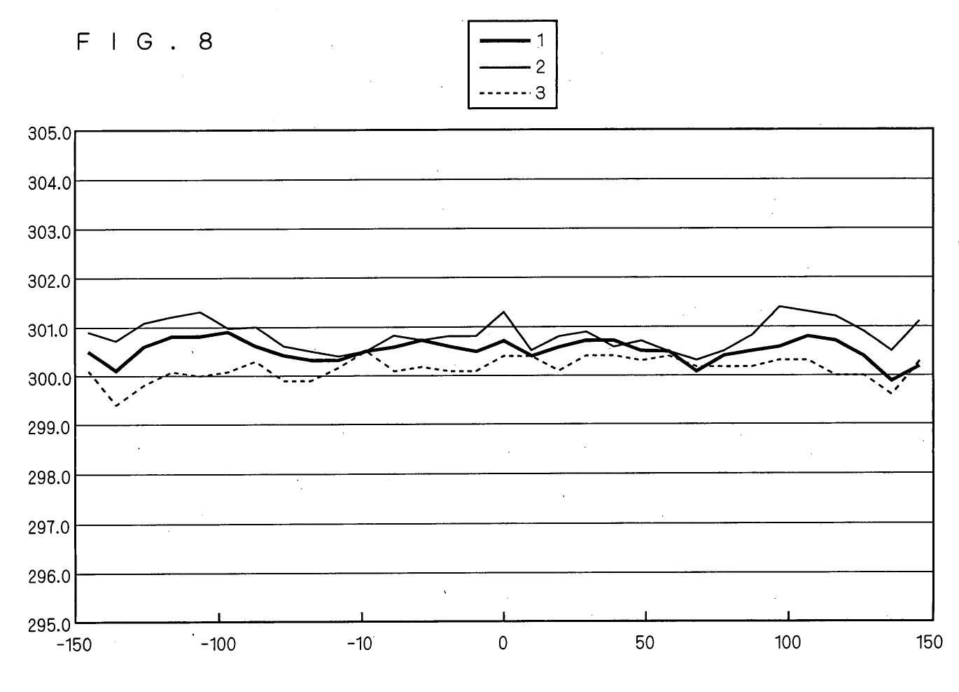

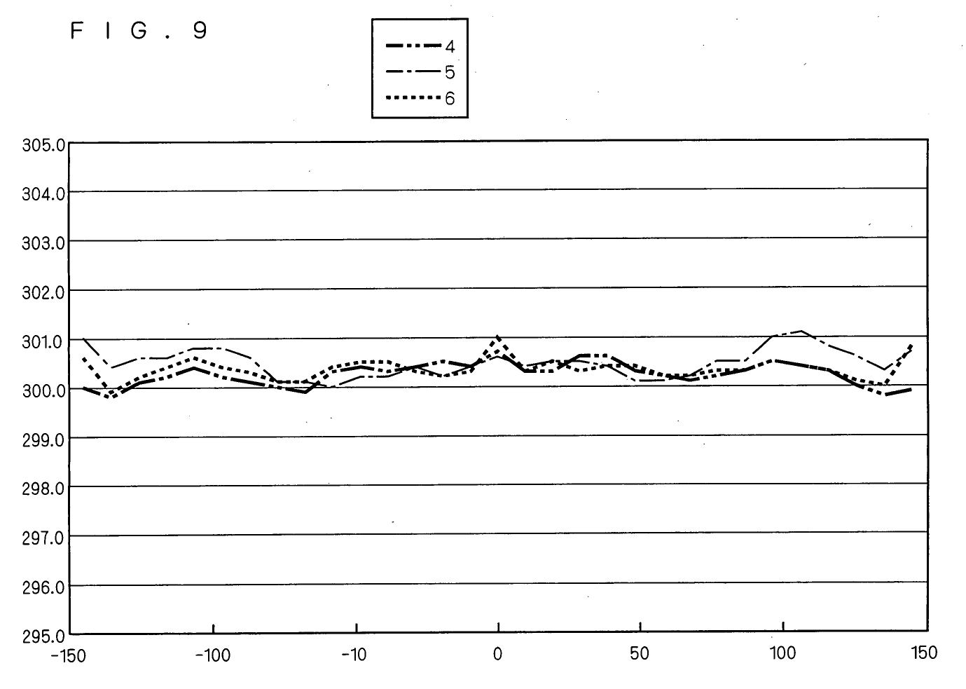

FIG. 8 shows variations of a film thickness taken along the diameter of a thin film of each of three substrates W processed in the apparatus of the background art. The three substrates W shown in FIG. 8 (respectively identified by graphs 1, 2 and 3) are those processed at the different coating units A, B and C. FIG. 9 shows variations of a film thickness taken along the diameter of a thin film of each of three substrates W processed in the substrate processing apparatus 100. The three substrates W shown in FIG. 9 (respectively identified by graphs 4, 5 and 6) are those processed at the different coating processing units 20a, 20b and 20c. In FIGS. 8 and 9, the amount of overlap among the graphs indicates the magnitude of the difference among units regarding substrates W processed in the respective coating units.

In the substrate processing apparatus 100, the second coating processing units 20a, 20b and 20c are vertically stacked at different heights. If a simple downflow as generated in the apparatus of the background art is also generated in such processing units at different heights, the difference of pressure is significant between the higher processing unit (near the outlet of a downflow and placed at high pressure) and the lower processing unit (near the exhaust outlet and placed at low pressure). The difference among units is more noticeable as compared to planar arrangement of units, especially when these units are responsible for processing such as coating that is susceptible to the influence of pressure.

This difference among units is clearly shown in FIG. 7. As seen from the processing results obtained in the background-art apparatus, there is a difference of as much as 0.7 nm between the substrate W having the smallest mean thickness (substrate W processed in the coating unit C) and the substrate W having the largest mean thickness (substrate W processed in the coating unit B). Further, the graphs of FIG. 8 do not overlap in a desirable manner.

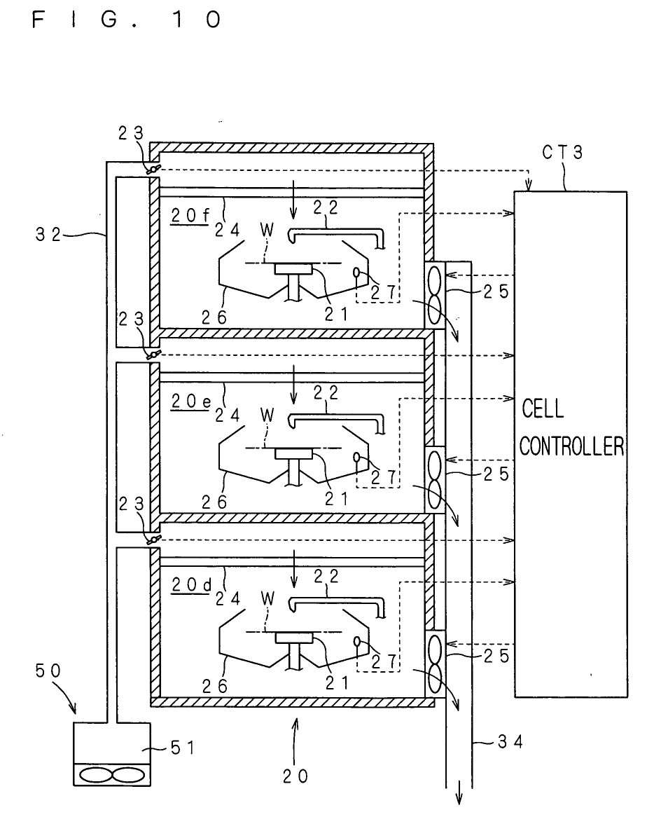

In contrast, in the substrate processing apparatus 100, the difference is controlled at 0.3 nm between the substrate W with the smallest mean thickness and the substrate W with the largest mean thickness as seen from FIGS. 8 and 10. It is also seen from FIG. 9 that the graph of each substrate W shows small variations.

As discussed, in the substrate processing apparatus 100 of the first preferred embodiment, pressure control in a plurality of processing units responsible for substantially the same processing (such as the second coating processing units 20a, 20b and 20c) is such that these processing units provide substantially the same processing result. Thus the difference among units can be reduced.

The pressure within each of a plurality of processing units is controlled based on the setting previously obtained. Thus the pressure within each of the plurality of processing units is easily controlled such that these processing units provide substantially the same processing result.

In the substrate processing apparatus 100, a plurality of processing units responsible for substantially the same processing are arranged at different heights. Thus as compared to the background-art apparatus, pressure control in the substrate processing apparatus 100 has a higher degree of effectiveness.

Further, the angle of rotation of each control plate 23 is adjusted such that the amount of air supply from the gas supply mechanism 50 to each of a plurality of processing units is controlled. Thus pressure control can be facilitated.

The gas supply mechanism 50 has the control mechanism 51 for controlling the temperature and humidity of air to be supplied. Thus the processing conditions in each processing unit can be suitably controlled.

In each of a plurality of processing units, air is supplied from the upper part and the internal atmosphere is discharged from the lower part. Thus particles can be effectively eliminated.

In the substrate processing apparatus 100 of the first preferred embodiment, each of a plurality of processing units is controlled based on the setting such that these processing units provide substantially the same result. A way of controlling pressure is not limited to feed-forward control. Alternatively, real-time control may be employed based on measured values obtained in processing.

FIG. 10 shows the second coating processor 20 of a second preferred embodiment of the present invention. Except that the second coating processing units 20a, 20b and 20c are replaced respectively by second coating processing units 20d, 20e and 20f, the substrate processing apparatus 100 of the second preferred embodiment is substantially the same in configuration as the substrate processing apparatus 100 of the first preferred embodiment. The same structures as those in the substrate processing apparatus 100 of the first preferred embodiment are identified by the same reference numerals, and the description thereof will be suitably omitted.

The second coating processing units 20d, 20e and 20f each have a cup 26 for covering a substrate W held on the spin chuck 21, and a pressure sensor 27 arranged in the cup 26. The cup 26 serves to receive a coating of a solution scattered off by the rotation of a substrate W to collect the received solution into a certain mechanism. The pressure sensor 27 serves to measure the pressure within each of the second coating processing units 20d, 20e and 20f, especially in each cup 26 to transmit the measured result (result of detection) to the cell controller CT3 at a certain time.

Next, it will be discussed how the substrate processing apparatus 100 of the second preferred embodiment operates. The description of the operations similar to those of the substrate processing apparatus 100 of the first preferred embodiment will be suitably omitted.

First, the substrate processing apparatus 100 of the second preferred embodiment performs the similar operations to those in the substrate processing apparatus 100 of the first preferred embodiment to also follow steps S1 through S6.

Next, in the coating process of step S7, a substrate W is held onto the spin chuck 21 and the cup 26 moves up to a predetermined position, thereby transferring the substrate W into the cup 26. At this time, the pressure sensor 27 sends the measured pressure to the cell controller CT3.

The cell controller CT3 compares the measured pressure with a pressure defined as a default value at the start of coating. When the measured pressure is lower than the default value, the angle of rotation of each control plate 23 is adjusted to be closed to the horizontal, thereby increasing the degree of opening of the supply path 32. When the measured pressure is higher than the default value, the angle of rotation of each control plate 23 is adjusted to be close to the vertical, thereby lowering the degree of opening of the supply path 32. The pressure within the cup 26 is thereby controlled to a prescribed value, at which time coating is performed by applying a coating of a solution from the nozzle 22 while rotating a substrate W.

When a substrate W is subjected to coating at each of the second coating processing units 20d, 20e and 20f, the pressures within the cups 26 are controlled to have a prescribed value (same value). Thus, in the substrate processing apparatus 100 of the second preferred embodiment, each pressure within the second coating processing units 20d, 20e and 20f is easily controlled such that these processing units provide substantially the same processing result.

When the coating process of step S7 ends, the flow proceeds to step S8 at which the substrate W after being subjected to coating is taken out from any one of the second coating processing units 20d, 20e and 20f for post-stage processing.

As discussed, the substrate processing apparatus 100 of the second preferred embodiment provides the similar effects to those obtained in the substrate processing apparatus 100 of the first preferred embodiment.

For pressure control in the second coating processing units 20d, 20e and 20f, the angle of rotation of each control plate 23 is adjusted based on the measured result sent from each pressure sensor 27 such that the pressures within the cups 26 exerting great influence upon coating have substantially the same value. Then the second coating processing 20d, 20e and 20f and more specifically, the cups 26 can be placed under substantially the same pressure, thus facilitating control to provide substantially the same processing result.

Further, real-time control by means of the pressure sensors 27 is flexibly responsive for example to changes over time of the intake filter units 24.

Like the second coating processing units 20d, 20e and 20f, a pressure sensor may also be provided to the first coating processing units 8a, 8b and 8c of the BARC block 2, or to the development units 40a through 40e of the development processor 40.

As an alternative to the pressure control in the preferred embodiments of the present invention described so far, feed-back control may be employed for pressure control in a plurality of processing units. In this case, the thicknesses of thin films formed on substrates W processed in the substrate processing apparatus 100 may be measured for example in an inspection device. Based on the results of measurement, the angle of rotation of each control plate 23 or 43, or the speed of rotation of the fan of each exhaust fan unit 25 or 45 may be controlled.

The order in which the substrate processing apparatus 100 of the preferred embodiments of the present invention operates is not limited to the flow shown in FIG. 6. As long as the same effects are obtained, the order of steps may be suitably changed.

In the substrate processing apparatus 100 of the second preferred embodiment, the pressure sensor 27 may measure the pressure within each cup 26 at a different time. As an example, the pressure sensor 27 may measure the pressure and send the result to the cell controller CT3 at regular intervals.

While the invention has been shown and described in detail, the foregoing description is in all aspects illustrative and not restrictive. It is therefore understood that numerous modifications and variations can be devised without departing from the scope of the invention.

What is claimed is:

1. A substrate processing aparatus for performing processing on a substrate, comprising:
a plurality of processing units responsible for the same processing on a plurality of substrates; and
a pressure control element for controlling the pressures within said plurality of processing units such that said plurality of processing units provide substantially the same processing result.

2. The substrate processing apparatus according to claim 1,
wherein said pressure control element controls the pressure within each of said plurality of processing units based on a value previously determined.

3. The substrate processing apparatus according to claim 1, further comprising:
a sensor for measuring the pressures within said plurality of processing units,
wherein said pressure control element controls the pressures within said plurality of processing units based on the pressures measured by said sensor such that said plurality of processing units are placed under substantially the same pressure.

4. The substrate processing apparatus according to claim 1,
wherein said plurality of processing units include units arranged at different heights.

5. The substrate processing apparatus according to claim 1,
wherein said pressure control element comprises a supply element for supplying gas to said plurality of processing units, and
wherein said pressure control element controls the amount of gas supply from said supply element.

6. The substrate processing apparatus according to claim 5,
wherein said supply element comprises a control element for controlling the temperature and humidity of said gas to be supplied to said plurality of processing units.

7. The substrate processing apparatus according to claim 5,
wherein said supply element supplies said gas from an upper part into each of said plurality of processing units.

8. The substrate processing apparatus according to claim 1,
wherein said pressure control element further comprises a discharge element for discharging the atmosphere within each of said plurality of processing units, and
wherein said pressure control element controls the amount of discharge of said atmosphere through said discharge element.

9. The substrate processing apparatus according to claim 8,
wherein said discharge element discharges said atmosphere from a lower part of each of said plurality of processsing units.

10. The substrate processing apparatus according to claim 1,
wherein each of said plurality of processing units applies a coating of a predetermined processing solution onto a substrate.

11. The substrate processing apparatus according to claim 10,
wherein said plurality of processing units each comprise:
a rotation mechanism for rotating a substrate while holding said substrate;
a cup for covering said substrate held on said rotation mechanism; and
a nozzle for applying said predetermined processing solution onto a surface of said substrate rotated by said rotation mechanism,
wherein said pressure control element controls the pressure within said cup.

12. A substrate processing method, comprising the steps of:
(a) performing the same processing on a plurality of substrates using a plurality of processing units; and
(b) controlling the pressures within said plurality of processing units such that said plurality of processing units provide substantially the same processing result.

13. The substrate processing method according to claim 12,
wherein in said step (b), the pressure within each of said plurality of processing units is controlled based on a value previously determined.

14. The substrate processing method according to claim 12, further comprising the step of:
(c) measuring the pressures within said plurality of processing units,
wherein in said step (b), the pressures within said plurality of processing units are controlled based on the pressures measured in said step (c) such that said plurality of processing units are placed under substantially the same pressure.

15. The substrate processing method according to claim 12,
wherein said plurality of processing units include units arranged at different heights.

16. The substrate processing method according to claim 12,
wherein in said step (b), the amount of gas supply to said plurality of processing units is controlled.

17. The substrate processing method according to claim 16, further comprising the step of:
(d) controlling the temperature and humidity of said gas to be supplied to said plurality of processing units.

18. The substrate processing method according to claim 16,
wherein in said step (b), said gas is supplied from an upper part into each of said plurality of processing units.

19. The substrate processing apparatus according to claim 12,
wherein in said step (b), the amount of discharge of an atmosphere from each of said plurality of processing units is controlled.

20. The substrate processing apparatus according to claim 19,
wherein in said step (b), said atmosphere is discharged from a lower part of each of said plurality of processing units.

21. The substrate processing method according to claim 12,
wherein in said step (a), a coating of a predetermined processing solution is applied onto said plurality of substrates.

22. The substrate processing method according to claim 21,
wherein said step (a) comprises the steps of:
(a-1) rotating a substrate while holding said substrate in a cup covering said substrate; and
(a-2) applying said predetermined processing solution onto a surface of the rotating substrate during execution of said step (a-1), and
wherein in said step (b), the pressure within said cup is controlled.
